(19) United States
(12) Patent Application Publication
(10) Pub. No.: US 2002/0107680 A1
(43) Pub. Date: Aug. 8, 2002

(54) Method for providing performance data of a web server

(75) Inventors: Richard K. Duggan, Toronto (CA); Harm Sluiman, Scarborough (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/778,619

(22) Filed: Feb. 7, 2001

(51) Int. Cl. G06F 9/45

(52) U.S. Cl. 703/22

(57) ABSTRACT

A system and method for the publication of performance data over a network for access by a plurality of performance tools. In response to HTTP calls, the performance data is provided to performance tools over a network in XML data structures.

### FIELD OF INVENTION

This invention relates to monitoring the performance status of applications and in particular to a method for providing performance data of a web server.

### BACKGROUND OF THE INVENTION

It is essential to monitor the performance status of applications once they are deployed and, in particular, where such applications are deployed over the Internet or the World-Wide Web (“Web”) and where they must provide a certain quality of service. Prior art monitoring programs (“performance tools”) typically comprise of three parts: collection, transport, and analysis. The collection may further include a data filtering function to reduce the data collected. The performance data is typically collected into large files for later transport and analysis. An example of such a performance tool is revealed in U.S. Pat. No. 5,067,107 entitled “Continuous Computer Performance Measurement Tool That Reduces Operating System Produced Performance Data for Logging into Global, Process, and Workload Files”.

These prior art performance tools have a number of disadvantages due to propriety standards used by various vendors. The disadvantages include a high cost for developing the transport and analysis parts for each new application to be monitored; a lack of efficiency in that a performance tool can not be used to monitor a number of different applications from different vendors and that an application can not be monitored by a number of different performance tools from different vendors.

There also exists a number of richly functioned performance tools that have already been deployed for performance monitoring of applications. It would be costly to have to re-write and to leverage these performance tools to monitor new applications. However, by divorcing the collection and transport functions from the analysis function, the above disadvantages can be reduced. The “publication” of performance data for analysis by performance tools of a number of difference vendors is advantageous. It would be possible to create performance tools that work independently of the applications being monitored. It is therefore an aspect of an object of the present invention for providing “publication” of performance data to such performance tools.

Performance data in this document refers to information that provides a snapshot or a quick scan of what is currently happening on a computing system or server. It includes data like how much memory is being used by what process.

### SUMMARY OF THE INVENTION

According to an aspect of the invention, there is provided a method for a servlet of an Application server running on a Web server to provide performance data to a performance tool running on a client computer, where the Web server and the client computer are in communication over a network using a network protocol, said method for said servlet comprising: receiving a request for performance data from the performance tool, where the request is transported over the network; obtaining the performance data as per the request; formatting the performance data into a data structure; and providing the data structure for transport to the performance tool over the network.

According to another aspect of the invention, there is provided a monitoring system embedded within a computing system for providing performance data to a performance tool running on a client computer, where the computing system and the client computer are in communication over a network using a network protocol, comprising: a communication system to receive a request for performance data from the performance tool, where the request is transported over the network; a data collection system to obtain the performance data as per the request; and a processing system to format the performance data into a data structure; wherein the communication system provides the data structure for transport to the performance tool over the network.

According to another aspect of the invention, there is provided an article to provide performance data of a computing system to a performance tool running on a client computer, where the computing system and the client computer are in communication over a network using a network protocol, comprising: a computer-readable storage medium for the computing system; means recorded on the medium for the computing system to receive a request for performance data from the performance tool, where the request is transported over the network; means recorded on the medium to obtain the performance data as per the request; means recorded on the medium to format the performance data into a data structure; and means recorded on the medium to provide the data structure for transport to the performance tool over the network.

According to another aspect of the invention, there is provided means recorded on the medium to provide the data structure for transport to the performance tool over the network.

According to another aspect of the invention, there is provided a method for a performance tool running on a client computer to retrieve performance data from a servlet of an Application server running on a Web server, where the Web server and the client computer are in communication over a network using a network protocol, said method for said performance tool comprising: sending a request for performance data to the servlet, where the request is transported over the network; and receiving a data structure containing the performance data transported from the servlet over the network.

According to another aspect of the invention, there is provided a performance tool embedded within a client computer which retrieves performance data from a servlet of a computing system, where the computing system and the performance tool are in communication over a network using a network protocol, comprising: a processor to provide a request for performance data where the request is transported to the computing system over the network; and to receive a data structure containing the performance data transported from the computing system over the network.

According to another aspect of the invention, there is provided an article of a performance tool running a client computer for retrieving performance data from a servlet of a computing system, where the computing system and the performance tool are in communication over a network using a network protocol, comprising: a computer-readable storage medium; means recorded on the medium for providing a request for performance data for transport to the computing system over the network; and means recorded on the medium for receiving a data structure containing the performance data transported from the computing system over the network.

### BRIEF DESCRIPTION OF THE DRAWINGS

In the accompanying drawings:

FIG. 1 illustrates an overview of a performance monitoring system in accordance with a preferred embodiment of the present invention; and

FIG. 2 illustrates a flowchart outlining the steps for processing a request by a servlet 110 in accordance with FIG. 1.

### DETAILED DESCRIPTION OF THE PREFERRED EMBODIMENTS

Operating systems run applications. The applications ask the operating system for services, like getting a file. A Web server is an application, or may be a set of applications, running in an operating system providing web services to the Internet. The Web server can run sub-processes independent of the operating system. It does its own control. One of the things it can run is an Application server. An Application server in turn also runs sub-processes called servlets (“servlets”). Alternatively, a Web server may run servlets.

In a preferred embodiment, a middleware is used to collect performance data for access by other sub-processes through an application program interface (“API”). The middleware is a part of the Application server. The servlet may poke the Application server to obtain the performance data; however, other known means of obtaining performance data are also available.

Alternately, the Web server may keep performance data on the processes that it is running to provide a snapshot of what is currently happening on the server. The performance data is accessible through an API to sub-processes.

The present invention utilizes the existing Internet communication infrastructure for performance tools to provide a facility to transport collected performance data and to provide a standard interface between the collection and the analysis parts. The existing Internet communication infrastructure uses a network protocol known as Transport Control Protocol using Internet Protocol or TCP/IP. However, other embodiments using different network protocols may also be used.

A collection part, such as a servlet, is provided on an Application server to obtain the desired performance data in response to a request from a performance tool running on a client computer. The request is a Hypertext Transfer Protocol (“HTTP”) “Get” or “Post”. HTTP for the purposes of this document includes HTTP secured. Alternatively, another protocol providing similar functionality can of course be used. The response accordingly provides the performance data in the format of a standard Internet data structure such as Hypertext Markup Language (“HTML) or Extensible Markup Language (“XML”) to the requesting program.

The analysis part is preferably implemented as a Java application in a browser as a Java applet, but other techniques such as Extensible Style Language style sheets can also be used for rendering the data. The browser is used to render the performance data as desired. The existing browser rendering and communications functions are leveraged so that these functions do not have to be developed by the performance tool vendors, and thereby reducing the cost of development. The performance tool vendors can instead concentrate on their core function of analyzing performance data. One or more different performance tools can, of course, concurrently request performance data from servlets of an Application server for different purposes.

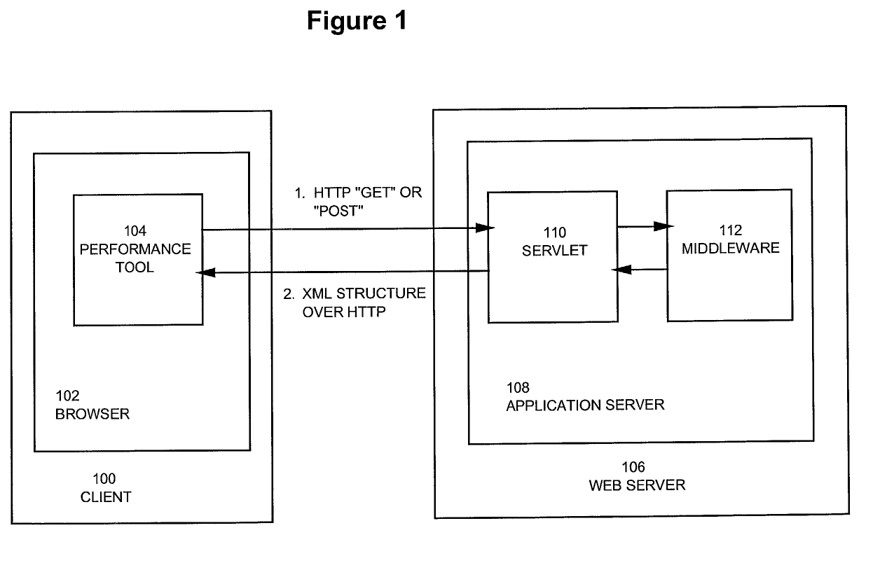

Referring to the drawings and initially to FIG. 1, there is illustrated an overview of a performance monitoring system in accordance with a preferred embodiment of the present invention comprising a client computer 100 having a browser 102 that is running a Java application, a performance tool 100; and a Web server 106 running an Application server 108 having a servlet 1 10 to obtain performance data from a middleware 1 12. The performance tool 100 issues HTTP “Get” or “Post” requests. For each request, the servlet 112 obtains the desired performance data and formatting the data as a XML data structure, a XML document, for transport to the performance tool 100 via communication services provided by the Web server 106. The performance data is thus received for rendering and analysis by the performance tool 100.

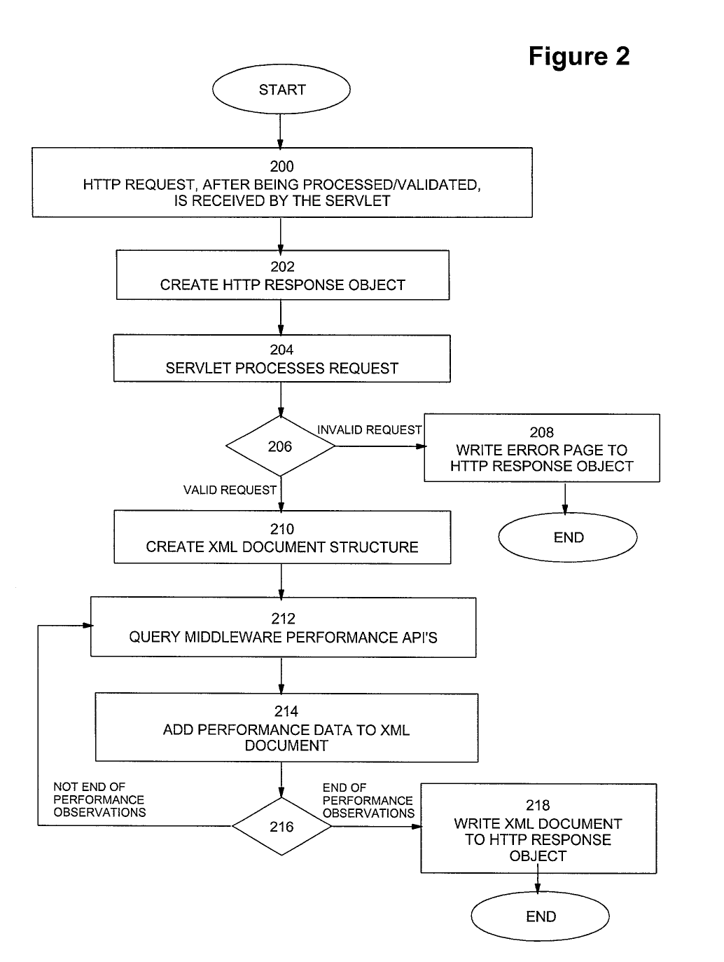

Referring to FIG. 2, there is illustrated a flowchart outlining the steps for processing an HTTP request by the servlet 110 in accordance with FIG. 1 of the present invention. Upon receiving and validating the HTTP request, the Web server 106 initiates execution of the servlet 1 10 if it is not already running. The servlet 110 receives the HTTP request (step 200) and creates a HttpResponse Object (step 202). The servlet 1 10 processes the request i.e. parses the request, (step 204) and determines whether the request is valid or invalid (step 206). If the request is invalid then an error page is written to the HttpResponse Object for transport to the performance tool 104 (step 208) and the execution of the servlet ends. If the request is valid then a data structure in XML format, a XML document, is then created (step 210) and the API of the middleware 112 is queried for performance data (step 212). The obtained performance data is stored in the data structure (step 214). The servlet then determines if further performance observations are required as per the Http request (step 216). If further performance observations for performance data are required then the steps are repeated from step 212, querying for performance data. When no further performance observations are required then the data structure is written to the HttpResponse Object (step 208) and the execution of the servlet ends. The HttpResponse Object is then passed to the Web server for transport to the requesting performance tool.

Although preferred embodiments of the invention have been described herein, it will be understood by those skilled in the art that variations may be made thereto without departing from the spirit of the invention or the scope of the appended claims.

The embodiments of the invention in which an exclusive property or privilege is claimed are defined as follows:

1. A method for a servlet of an Application server running on a Web server to provide performance data to a performance tool running on a client computer, where the Web server and the client computer are in communication over a network using a network protocol, said method for said servlet comprising:
receiving a request for performance data from the performance tool, where the request is transported over the network;
obtaining the performance data as per the request;
formatting the performance data into a data structure; and
providing the data structure for transport to the performance tool over the network.

2. A method of claim 1, wherein the data structure is provided to the Web server for transport.

3. A method of claims 1 or 2, wherein the request is formatted in HTTP.

4. A method of claims 1, 2, or 3, wherein the data structure is formatted in XML.

5. A method of claims 1, 2, 3, or 4, wherein the network protocol is TCP/IP.

6. A computer program comprising computer program code means adapted to perform all of the steps of any of claims 1 to 5 when said program is run on a computer.

7. A computer program as claimed in claim 6 embodied on a computer readable medium.

8. A monitoring system embedded within a computing system for providing performance data to a performance tool running on a client computer, where the computing system and the client computer are in communication over a network using a network protocol, comprising:
a communication system to receive a request for performance data from the performance tool, where the request is transported over the network;
a data collection system to obtain the performance data as per the request; and
a processing system to format the performance data into a data structure;
wherein the communication system provides the data structure for transport to the performance tool over the network.

9. A monitoring system of claim 8, wherein the data structure is provided to the computing system for transport.

10. A monitoring system of claims 8 or 9, wherein the request is formatted in HTTP.

11. A monitoring system of claims 8, 9 or 10, wherein the data structure is formatted in XML.

12. A monitoring system of claims 8, 9, 10 or 11, wherein the network protocol is TCP/IP.

13. An article to provide performance data of a computing system to a performance tool running on a client computer, where the computing system and the client computer are in communication over a network using a network protocol, comprising:
a computer-readable storage medium for the computing system;
means recorded on the medium for the computing system to receive a request for performance data from the performance tool, where the request is transported over the network;
means recorded on the medium to obtain the performance data as per the request;
means recorded on the medium to format the performance data into a data structure; and
means recorded on the medium to provide the data structure for transport to the performance tool over the network.

14. An article of claim 13, wherein the data structure is provided to the computing system for transport.

15. An article of claim 13 or 14, wherein the request is formatted in HTTP.

16. An article of claims 13, 14 or 15, wherein the data structure is formatted in XML.

17. An article of claims 13, 14, 15 or 16, wherein the network protocol is TCP/IP.

18. A method for a performance tool running on a client computer to retrieve performance data from a servlet of an Application server running on a Web server, where the Web server and the client computer are in communication over a network using a network protocol, said method for said performance tool comprising:
sending a request for performance data to the servlet, where the request is transported over the network; and
receiving a data structure containing the performance data transported from the servlet over the network.

19. A method of claim 18, wherein the request is provided to the client computer for transport over the network to the servlet.

20. A method of claims 18 or 19, wherein the request is formatted in HTTP.

21. A method of claims 18, 19 or 20, wherein the data structure is formatted in XML.

22. A method of claims 18, 19, 20 or 21, wherein the network protocol is TCP/IP.

23. A computer program comprising computer program code means adapted to perform all of the steps of one of claims 18 to 22 when said program is run on a computer.

24. A computer program as claimed in claim 23 embodied on a computer readable medium.

25. A performance tool embedded within a client computer which retrieves performance data from a servlet of a computing system, where the computing system and the performance tool are in communication over a network using a network protocol, comprising:
a processor to provide a request for performance data where the request is transported to the computing system over the network; and to receive a data structure containing the performance data transported from the computing system over the network.

26. A performance tool of claim 25, wherein the request is provided to the client computer for transport over the network to the servlet.

27. A performance tool of claims 25 or 26, wherein the request is formatted in HTTP.

28. A performance tool of claims 25, 26 or 27, wherein the data structure is formatted in XML.

29. A performance tool of claims 25, 26, 27 or 28, wherein the network protocol is TCP/IP.

30. An article of a performance tool running a client computer for retrieving performance data from a servlet of a computing system, where the computing system and the performance tool are in communication over a network using a network protocol, comprising:
a computer-readable storage medium;
means recorded on the medium for providing a request for performance data for transport to the computing system over the network; and
means recorded on the medium for receiving a data structure containing the performance data transported from the computing system over the network.

31. An article of claim 30, wherein the request is provided to the client computer for transport over the network to the servlet.

32. An article of claims 30 or 31, wherein the request is formatted in HTTP.

33. An article of claims 30, 31 or 32, wherein the data structure is formatted in XML.

34. An article of claims 30, 31, 32 or 33, wherein the network protocol is TCP/IP.
